(19) United States
(12) Patent Application Publication
(10) Pub. No.: US 2009/0235429 A1
(43) Pub. Date: Sep. 24, 2009

(54) ELASTOMERIC ARTICLE WITH PATTERNED SURFACE TO CONTROL TACK OR GRIP

(75) Inventors: Simon Pickard, Cheadle Hulme (GB); Christine Leeming, Manchester (GB)

Correspondence Address: JOHN S. PRATT, ESQ;KILPATRICK STOCKTON, LLP, 1100 PEACHTREE STREET, SUITE 2800, ATLANTA, GA, 30309, US

(73) Assignee: REGENT MEDICAL LIMITED, Irlam ,Manchester (GB)

(21) Appl. No.: 12/307,923

(22) PCT Filed: Jul. 2, 2007
(86) PCT No.: PCT/GB2007/002467

§ 371 Date: Jan. 8, 2009

(30) Foreign Application Priority Data
Jul. 11, 2006 (GB) 0613853.1

(51) Int. Cl. A41D 19/00; B05D 5/00; B32B 3/00; B05D 1/32

(52) U.S. Cl. 2/161.7; 427/261; 2/161.8; 428/195.1; 427/282

(57) ABSTRACT

An elastomeric article includes a region that is covered with adhesive material, the adhesive material being partially coated with slippery material so as to reduce the surface area of exposed adhesive material, thereby controlling the amount of adhesion exhibited by said region. The elastomeric article is formed with a region of adhesive material, and a slippery material is applied so as to at least partially cover an underlying adhesive material. The slippery material may be applied so as to only partially cover the adhesive, or applied to completely cover the adhesive material and then etched using solvent to expose the underlying adhesive material, or applied in conjunction with a masking material.

Elastomeric Article with Patterned Surface to Control Tack or Grip The present invention relates to elastomeric articles such as gloves, condoms verucca socks and the like, in particular to surgical gloves, providing a method for controlling the adhesion between the elastomeric material and surfaces the elastomeric article contacts. Examples of the surfaces that may interact with such an article include but are not restricted to; the users skin, apparel the user wears under the article and objects the user comes into contact with whilst wearing said article.

Surgical gloves are designed to be worn over surgical gowns which were typically cotton based, but recently there have been significant advancements in the material for such gowns, including improvement in the impermeability of the materials achieved by treating the material with a hydrophobic moiety that improves the moisture repellent characteristics of the material. The material from which surgical gloves are typically made has a tacky, adhesive quality, and in order to facilitate the fitting and removal of the gloves onto and from the hands of the user, the formed glove is treated with a slippery material. However, an ongoing problem with existing glove and gown designs is that the slippery surfaces of the gloves give rise to a tendency for the cuff of the glove to move down the gown during use, exposing the woven cuff of the gown and hence presenting a risk of strike through of potentially infectious material.

The elastomeric materials used to manufacture such articles are often tacky in nature. The tackiness of said material results in adhesion between the article and other surfaces. Elastomeric articles are often treated to reduce the tackiness of the surface. This treatment infers a number of advantages on said article resulting in benefits such as: articles that are easier to don, articles that do not stick together and articles with controlled levels of grip.

In order to aid donning of gloves, the application of a hydrophilic polymer layer to an elastomeric article such as a surgeon's glove has been suggested by Podell and Podell (U.S. Pat. No. 4,499,154). This patent suggests the application of a hydrogel layer of poly(2-hydroxy ethyl methacrylate) (polyHEMA) on the inner surface of a rubber surgeon's glove would act as a donning aid. Subsequent work (U.S. Pat. No. 4,575,476) demonstrated that a hydrogel terpolymer of HEMA, methacrylic acid (MAA) and 2-ethyl hexyl acrylate (EHA) could act as a donning aid if attached to the surface of a natural rubber glove by crosslinking with the aid of a melamine formaldehyde resin. This results in a slippery polymer layer covering the inner surface of the glove.

However, this method provides little control over the degree of slipperiness exhibited by the treated article. Decreasing the amount of polymer deposited on the article by changing the concentration of the polymer solution applied would be thought to lead to a control of the degree of tack the article exhibits. However, decreasing the amount of polymer deposited is difficult to control. This often results in a variation in the degree of tack observed over the article as the slippery material is deposited in patches rather than uniformly over the surface.

Gloves have also been designed having textured wrist portions which are moulded into the material of the glove during the glove moulding process. For example, U.S. Pat. No. 4,095,293 discloses a moulded glove having a plurality of longitudinal channels moulded around the circumference of the wrist portion of the glove together with a plurality of circumferential grooves in the region of the mouth of the glove which operate to prevent roll down. However, this arrangement has the problem that the moulding of the grooves into the glove causing a thinning of material around the wrist and cuff. Furthermore, due to the manner in which the grooves are moulded and the fact that the glove is turned inside out upon removal from the former, the grooves will end up on the outside of the glove and the glove hence needs to be reinverted prior to use in order for the grooves to perform their gripping function.

(US2006059604) describes a surgical glove, comprising a hand portion and a wrist portion extending from the hand portion and terminating in a hand insertion opening, the wrist portion including a region of tacky material formed by an unfinished region of the glove, in use, will form the inside of the glove, whereby, in use, the tacky portion will adhere to the cuff of a garment worn by the user, thereby preventing roll-down of the glove.

However, the tack of the unfinished material can introduce problems in manufacture and use of the glove. The untreated regions of the wrist have a tendency to stick to each other, when this occurs these then have to be separated in the manufacturing process and before use.

The present invention provides a means of controlling this problem by providing a pattern of slippery material to moderate the amount of tacky material exposed at the cuff of the glove. This allows the degree of tackiness in the wrist region to be controlled as the area of tacky glove material available to interact with other surfaces is controlled by the pattern of slippery material covering the glove. This provides a method of optimising the tack in the wrist region to allow ease of manufacture, whilst providing sufficient tack to prevent the glove rolling down the cuff of the surgical gown.

To that end, the present invention provides an elastomeric article including a region that is covered with adhesive material, the adhesive material being partially coated with slippery material so as to reduce the surface area of exposed adhesive material, thereby controlling the amount of adhesion exhibited by said region.

An elastomeric article in accordance with the invention has the advantage that pattern results in an article in which the tack is controlled since the patterned article or region of the article will have a coefficient of friction intermediary to that of the pattern forming material and that of the underlying adhesive material, as the pattern allows the amount of adhesive material exposed at the surface of the article to be controlled. To further describe this, if the slippery material has a coefficient of friction of y and the underlying adhesive material has a coefficient of friction of x. The resultant patterned area of the article will have a coefficient of friction between x and y. Hence it is possible to produce an article with optimal tack for use and processing thus over coming the problems described previously.

The present invention further provides a method of producing an elastomeric article with controlled tack according to the invention, comprising the steps of forming an elastomeric article with a region of adhesive material, and applying a slippery material so as to at least partially cover the region of adhesive material, a pattern of the adhesive material remaining exposed in the finished article, thereby controlling the amount of adhesion exhibited by said region.

As the untreated material is inherently tacky it will exhibit a higher coefficient of friction to other surfaces than the slippery material. Therefore by intermittently covering regions of the underlying material, the application of a pattern of slippery material can be used to control the degree of tack offered by the article.

Preferably the slippery material used to form the pattern is a relatively hard material that is applied over the soft, tacky under material. The pattern results in a surface consisting of domains of untreated latex interspaced between domains of hard slippery material. More preferably the hard material is a polymer and more preferably the polymer has a glass transition temperature in excess of 40° C. This invention is not limited to polymer materials but includes other hard materials or formulations of hard materials that can be deposited in a pattern on the surface of an elastomeric article. Examples of such patterning materials may include, but are not limited to, formulations used in printing inks, polymers such as hydrogel polymers and composites of hard inorganic materials in polymer binders.

The present invention is not limited to depositing a hard material in a pattern on to the elastomeric article, the material used to form the pattern may be a solution or soft in nature when deposited and the hard material is only formed after further treatment of the patterning material.

The treatment of the pattern, although not limited to, could include the application of heat to induce a reaction or removal of solvent from the material forming the pattern. This allows a soft material or a solution to be deposited and further treatment to produce a pattern of hard material.

The present invention thereby further provides a method of manufacture of an elastomeric article comprising the steps of coating a former with material to form the article, patterning said article with a substrate that will become hard on drying or further treatment.

The present invention further provides a method of manufacture of an elastomeric article comprising the steps of coating a former with material to form the article, carrying out a finishing operation on the article which produces a slippery surface over part of the article whilst leaving a portion untreated. The order of the finishing operation and the patterning operation may be inverted so the glove is patterned before fully finishing and the untreated region of the article as both processes would result in an equivalent product.

The pattern provided in the present invention can be produced by a number of patterning methods and is not restricted to one particular patterning method. The pattern can be produced by ink jetting printing solutions or dispersions of slippery material. Subsequent drying or reaction of the pattern results in a pattern of hard material. The hard pattern provides a means of partly covering the underlying glove material hence a means of controlling the amount of tacky material at the surface of the article available to interact with other surfaces hence controlling the degree of tack exhibited by the article.

The pattern of adhesive material may be produced directly by only partially covering the adhesive material with the slippery material or it may be achieved by performing an etching operation using a solvent after completely coating the adhesive with slippery material so as to remove selectively the slippery material, or even by use of a masking material which is applied to the adhesive material prior to application of the slippery material.

It is important that the material forming the pattern adheres to the elastomeric article throughout the use of the article. This ensures that the degree of tack will not vary with use and the material used to form the pattern does not fall off the article and cause problems in use. To optimise the adhesion of the coating to the article, the article can be pre-treated to change surface properties of the article to which the patterning coating is to be applied. This may be performed in a number of ways such as chemical treatment or solvent treatment. Chemical treatment results in an article with a surface chemistry that interacts with the coating, providing improved chemical adhesion between the article and the coating. Solvent treatment can have a number of consequences, such as surface roughening swelling of the underlying article or even precipitation of the printed coating all of which, either independently of combined, can result in better adhesion of the coating to the article.

A further adaptation of this invention would allow the whole of the elastomeric article to be treated with a pattern of hard material. This results in an article with controlled tack over the surface of the article. This is not limited to the application of a pattern of slippery material any particular surface of the article and includes internal parts of the article and the application of pattern to the outer surface of the article, hence providing a mechanism of controlling the grip of drag of the article.

Furthermore this includes applying a pattern of slippery material to any surface of an article, and varying the pattern over the article. This allows the tack of different parts of the article to be controlled. This patterning can be used as an aid to donning or to control grip of the external surfaces of the article.

One embodiment of this invention would be a surgical glove according to the invention comprising integrally formed hand and cuff portions, the cuff portion terminating in a hand opening by means of which a user may insert a hand into the glove. The glove is manufactured according to normal procedures familiar to those experienced in the art using a former or mould onto which elastomeric material, such as latex, is straight or coagulant dipped and dried to form a film, which is further dipped into a polymer solution, in which the dried polymer solution provides a slippery surface on the fingers hand and palm of the glove. The wrist portion of the glove is patterned with a further polymer solution using an inkjet printer. The dry polymer provides a pattern of slippery polymer that still has tacky elastomeric material exposed at the surface of the article. This allows the pattern and the amount of exposed material to the control the tack of the article

A further embodiment of this invention would be a surgical glove in which the glove is manufactured according to normal procedures familiar to those experienced in the art using a former or mould onto which elastomeric material, such as latex, is straight or coagulant dipped and dried to form a film. The film is then patterned with a polymer solution using an inkjet printer. The pattern produced is not uniform over all surfaces of the glove but the pattern is varied to control the amount of tack exhibited by different regions of the article. The polymer solution is then dried to form a pattern of slippery polymer that has regions of an underlying tacky elastomeric material exposed at the surface of the glove.

A further embodiment of this invention comprises a glove manufactured according to normal procedures familiar to those experienced in the art using a former or mould onto which elastomeric material, such as latex, is straight or coagulant dipped and dried to form a film, which is further dipped into a polymer solution, in which the dried polymer solution provides a slippery surface on the outer surface of the article, which forms the inner part of the glove when inverted. The article is then removed from the former and inverted. The outer surface of the glove is then patterned with a polymer solution using an inkjet printer. The polymer solution is then dried to form a pattern of slippery polymer domains interspersed with regions of the underlying tacky elastomeric material over the surface of the glove. The pattern is varied over the outer surface of the glove to produce varying level of grip on the glove.

In one embodiment, the slippery material is applied so as to cover completely the tacky material and a pattern of solvent is then applied to the slippery material, removing the slippery material and hence exposing the underlying tacky material in a pattern corresponding to the pattern of the applied solvent. The solvent is advantageously applied by printing but other techniques can be used. Typically the solvent dissolves or causes a rearrangement of the slippery material, exposing the underlying tacky material.

In a further embodiment, a masking material is applied (e.g. by printing) to the tacky material prior to covering the whole area with the slippery material. The mask and overlying slippery material are then removed so as to expose the underlying tacky material which is left in the pattern of the mask. The mask does not, however, necessarily have to be removed by a dedicated process—a masking material may be used which alters the surface energy of the article so as to prevent a subsequently applied polymer material to wet the region in which the mask is present. Silane is an example of one such masking material. Following application of the slippery material, the mask may then be removed to expose the underlying material, although this is not essential if the mask has a different coefficient of friction to the patterned coating as the mask may form the adhesive layer.

1. An elastomeric article including a region that is covered with adhesive material, the adhesive material being partially coated with slippery material so as to reduce the surface area of exposed adhesive material, thereby controlling the amount of adhesion exhibited by said region.

2. The elastomeric article according to claim 1, wherein the slippery material is applied in a pattern over the underlying adhesive material so as to only partially cover the adhesive material and thereby leave a pattern of said adhesive material exposed.

3. The elastomeric article according to claim 1, wherein the slippery material is applied so as to completely cover the adhesive material within said region, the slippery material being selectively removed by application of a pattern of solvent to the slippery material, thereby exposing the underlying adhesive material.

4. The elastomeric article according to claim 1, wherein a masking material is used to control the pattern of slippery material which is applied over the adhesive.

5. The elastomeric article according to claim 1 in which the article is a glove.

6. The elastomeric article according to claim 1 in which the untreated region of the article forms the cuff of the glove.

7. The elastomeric article according to claim 1, in which the pattern is formed on the internal surface of the glove.

8. The elastomeric article according to claim 1, in which the pattern is formed the external surface of the glove.

9. The elastomeric article according to claim 1 in which the slippery material that makes up the pattern is a hard substance.

10. The elastomeric article according to claim 9 in which the slippery material is a hard polymer.

11. The elastomeric article according to claim 10 in which the slippery material is a polymer with a glass transition temperature or crystallisation temperature in excess of 40° C.

12. The elastomeric article according to claim 9 in which the hard material is deposited and is further treated to produce a hard material.

13. The elastomeric article according to claim 1 in which the pattern is formed using one of an ink jet printer, a roller, and a silk screen printer.

14. A method of producing an elastomeric article with controlled tack according to claim 1, comprising the steps of forming an elastomeric article with a region of adhesive material, and applying a slippery material so as to at least partially cover the region of adhesive material, a pattern of the adhesive material remaining exposed in the finished article, thereby controlling the amount of adhesion exhibited by said region.

15. The method according to claim 13, wherein the slippery material is applied in a pattern so as to only partially cover the adhesive material.

16. The method according to claim 13, wherein the slippery material is applied so as to completely cover the adhesive material, the method including the further step of partially removing the slippery material from the adhesive material by applying a pattern of solvent, thereby exposing a pattern of adhesive material.

17. The method according to claim 15, wherein the solvent is applied by printing.

18. The method according to claim 13, including the further step of applying a pattern of masking material so as to partially cover the adhesive material prior to application of the slippery material, said masking material being removed following application of the slippery material so as to expose the underlying adhesive material.

19. The method according to claim 17, wherein the masking material is a material which alters the surface energy of the article so that the slippery material does not adhere thereto.

20. The method according to claim 18, wherein the masking material is silane.
